(19) United States
(12) Patent Application Publication
(10) Pub. No.: US 2026/0313335 A1
(43) Pub. Date: Oct. 8, 2026

(54) Aircraft Cabin Communications and Sensor System

(71) Applicant: Astronics Advanced Electronic Systems Corp., Kirkland, WA (US)

(72) Inventor: David Perchlik, Redmond, WA (US)

(21) Appl. No.: 19/640,254

(22) Filed: Apr. 6, 2026

Related U.S. Application Data
(60) Provisional application No. 63/783,606, filed on Apr. 4, 2025.

(51) Int. Cl. H04W 4/42; H04W 24/08; H04W 84/18

(52) U.S. Cl. CPC H04W 4/42; H04W 24/08; H04W 84/18

(57) ABSTRACT

Methods and apparatus for determining and communicating sensor status. An example of such a seat sensor system is for a mass transit vehicle that includes a mesh network of transmitters, with one transmitter connected to one or more sensor or a sensor data concentrator or a combination of sensors and data concentrators.

### CROSS-REFERENCE TO RELATED APPLICATIONS

This application is a Non-provisional application which claims priority to U.S. Provisional Application No. 63/783,606, filed on Apr. 4, 2025, and entitled “Aircraft Cabin Communications and Sensor System” the contents of which are incorporated by reference herein in its entirety.

### FIELD OF THE INVENTION

The present invention generally relates to the field of sensors, and more specifically relates to the field of sensors and wireless communication for detecting status of equipment and sensors, for example, in an aircraft.

### BACKGROUND OF THE INVENTION

In a mass transit vehicle, particularly commercial aircraft, it is valuable to have information as to the status of seats, passengers, equipment, consumables, latches, air quality, and space usage. In commercial aircraft the status of the above-mentioned items can be important to the flight operation. In the absence of sensors, the flight crew is responsible to visually inspect each item to determine the status of that item. When sensors are utilized to indicate the status of an item associated with the sensor (e.g., a seat), it is important to be able to have each sensor communicate its status to a centralized monitoring location so that the status of the numerous sensors may be easily observed.

For commercial air travel it is important to verify that each and every seat back is in an upright position, tray tables are stowed, passengers are in their seats with seatbelts fastened before takeoff, turbulence or landing. Again, such verification is typically performed by visual inspection by the flight crew. This process takes time and can delay the crew's ability to secure themselves and other equipment.

### SUMMARY OF THE INVENTION

In an embodiment, a sensor system for a mass transit vehicle includes sensors that are connected to a sensor input module. Each sensor is associated with a related item (e.g., a seat, tray table, etc.) and is used to indicate the status of that item (e.g., seat reclined, seat upright, tray table open, tray table closed, etc.). The sensor input module (SIM) is connected to a wireless radio transmitter/receiver. The SIM allows system flexibility in the type of sensor used and the ability to reduce wire length and overall weight by combining multiple sensors into one communication bus. In an embodiment, the radio transmitter/receivers are interconnected using a mesh network.

The mesh network includes an access point that processes the sensor information and has the capability to communicate the compiled sensor information to other systems and users of the information. The disclosed sensor system may be provided as part of a power and passenger service system (PPSS) which communicates directly to a crew terminal, or alternatively communicates to the crew terminal using a communications network, such as a mesh network.

### DESCRIPTION OF THE DRAWINGS

FIG. 1 is a block diagram of a cabin sensor communication system according to a first embodiment of the present invention;

FIG. 2 is a block diagram of a mesh network communication system according to an embodiment of the present invention;

FIG. 3A is a block diagram of a cabin electronics system according to an embodiment of the present invention utilizing a wireless data link module and a wireless data router concentrator;

FIG. 3B is a block diagram of a cabin electronics system according to an embodiment of the present invention utilizing a wireless data link module without a wireless data router concentrator;

FIG. 3C is a block diagram of a cabin electronics system according to an embodiment of the present invention utilizing a wireless data router concentrator without a wireless data link module; and

FIG. 3D is a block diagram of a cabin electronics system according to an embodiment of the present invention utilizing a wireless data link module and a wireless data router concentrator where the power and passenger service system (PPSS) communicates directly to a crew terminal.

### DETAILED DESCRIPTION OF THE INVENTION

In an embodiment, the present invention includes a sensor interface module. The sensor interface module provides power and communication to one or more sensors, which may include seat sensors associated with a particular seat. Specific types of sensors may include seat occupancy, tray table position, and seat back position types of sensors. The sensor interface module connects to the wireless data link module from which it receives power, and in turn may provide power to one or more sensors. The connection between the sensor interface module and sensors is typically a wired connection, although it is possible to have a wireless connection between the sensor interface module and one or more sensors. Such a wireless connection may be used to communicate information between the sensor interface module (either bidirectional or unidirectional) and to wirelessly provide power to the one or more sensors.

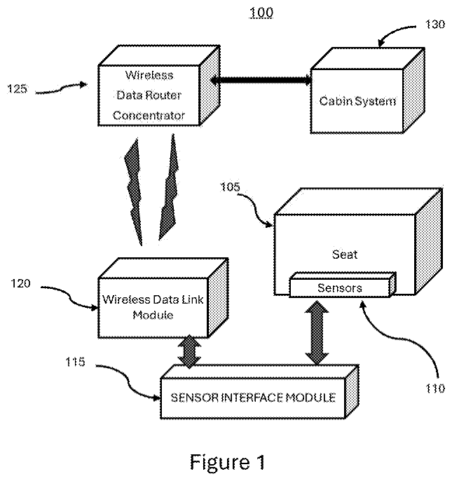

Referring now to FIG. 1, therein is illustrated a seat sensor system according to an embodiment of the present invention. As shown in FIG. 1, an aircraft seat 105 has a number of sensors 110 which indicate various conditions of the seat 105 and its immediate area (e.g., adjacent tray table, etc.). The sensors communicate with a sensor interface module 115, as described herein, which in turn communicates with a wireless data link module 120, as described herein. Such communications may be wired communications, or alternatively, one or more of such communications may be wireless.

The wireless data link module 120 communicates wirelessly with wireless data router concentrator 125, as described above, which in turn communicates with an onboard cabin system 130. In this way, the seat conditions, as indicated by the various sensors 110, may ultimately be collected and reported to the cabin system 130. The cabin system 130 may also provide instructions or control signals back to one or more seat sensors 110. As is well known, the seat 105 may be a portion of a seat group of a plurality of seats.

The sensor interface module 115 typically has a wired connection to the wireless data link module 120 in order to communicate information (either bidirectional or unidirectional) with the wireless data link module 120, as well as to receive power. The sensor interface module 115 in an embodiment includes a communication bus that interfaces to the wireless data link module 120. The sensor interface module receives as input signals from the various sensors 110 and includes appropriate circuitry to format or convert the sensor signals to be compatible with the communication bus. For analog sensors, this may involve utilizing an analog to digital converter as well as a related microprocessor. For sensors with digital output signals, the sensor interface module 115 may utilize a bus converter to convert the sensor signals to the proper format for the communication bus.

The wireless data link module 120 in an embodiment communicates on the same communication bus as the sensor input module 115. Alternatively, the wireless data link module 120 may include dedicated sensor inputs in implementations where a sensor input module 115 is not used. The sensor input signals are provided to a microprocessor (which may be separate or may be shared with other system components) by way of bus conversion circuits or bus multiplexors. The microprocessor converts the sensor signals into a digital stream of information that is then transmitted by downstream components of the system, such as wireless data router concentrator 125 as discussed further herein.

The sensor interface module 115 may be mechanically attached to the wireless data link module 120, such that it may be attached and de-attached to allow removal. In this way, several types of sensor interface modules 115 may be attached to the wireless data link module 120 as necessary. For example, different types of sensors 110 may need different types of sensor interface modules 115, and by having removable sensor interface modules 115, the different types of sensors 110 may be accommodated.

The sensor interface module 115 may be located in proximity to the sensors 110 it interfaces with, and as a result, the sensor interface module 115 may be located at a remote distance from the wireless data link module 120. In this way, this configuration may reduce the wire length and weight associated with the sensors 110, since the wiring from the sensors 110 to the sensor interface module 115 may be relatively short. In turn, there would be less wiring (and thus, less weight), since there would be fewer wires connecting the sensor interface module 115 to the wireless data link module 120, since a communication bus architecture may be used for this latter communication.

In an embodiment, the present invention includes a wireless data link module 120, as described herein. The wireless data link module 120 communicates (either bidirectional or unidirectional) with a wireless data router concentrator 125. This communication is typically wireless, although in certain applications it may be a wired type of communication. The wireless data router concentrator 125 in an embodiment includes a wireless radio transmitter (or alternatively transmitter and receiver) and optionally or alternatively an Ethernet access point. A microprocessor (which may be separate or may be shared with other system components) may be utilized by the wireless data router concentrator 125 to manage the input and output flow of communication. The wireless data router concentrator 125 may also include memory to store data for later extraction or download.

In certain embodiments, the communication between the wireless data link module 120 and the wireless data router concentrator 125, especially in the situation where there are multiple wireless data link modules 120, is by way of a mesh network. In general terms, when utilizing a mesh network for communication, one node of the mesh network (e.g., a wireless data link module 120) communicates with a nearby node (e.g., another wireless data link module 120), which in turn relays this communication to another nearby node, until the initial communication from the originating or first node is ultimately communicated to an endpoint, which in turn communicates to the wireless data router concentrator 125. In this way, nodes which are not sufficiently near the endpoint, may still be afforded with the opportunity to communicate with the endpoint by having the communications hop from one node to another nearby node until the communication is ultimately provided to the endpoint.

The mesh network may operate at a fixed frequency which is outside the WiFi channel in order to reduce interference with WiFi communications in the vicinity. The communication between a wireless data link module 120 and a wireless data router concentrator 125 may be in accordance with the 802.15.4 protocol. There are numerous IEEE 802.15 Protocol Stacks, which include: ZigBee: ZigBee is a Personal Area Network task group with a low-rate task group 4. It is a technology of home networking. ZigBee is a technological standard created for controlling and sensing the network. As is known, ZigBee is the Personal Area network of task group 4, so it is based on IEEE 802.15.4 and is created by Zigbee Alliance. 6LoWPAN: The 6LoWPAN system is used for a variety of applications including wireless sensor networks. This form of wireless sensor network sends data as packets and uses IPv6-providing the basis for the name-IPv6 over Low power Wireless Personal Area Networks. ZigBee IP: Zigbee IP is a standards-based wireless technology that was developed for low-cost and low-power wireless machine-to-machine (M2M) and internet of things (IoT) networks. ISA100.11a: This is a mesh network that provides secure wireless communication to process control. Wireless HART: This is also a wireless sensor network technology, which makes use of time-synchronized and self-organizing architecture. Thread: Thread is an IPv6-based networking protocol for low-power Internet of Things devices in IEEE 802.15. April 2006 wireless mesh network. Thread is independent of other 802.15 mesh networking protocols, such as ZigBee, Z-Wave, and Bluetooth LE. An implementation of the present invention may utilize “Thread”, but alternatively could utilize any of the above-described 802.15.4 stacks.

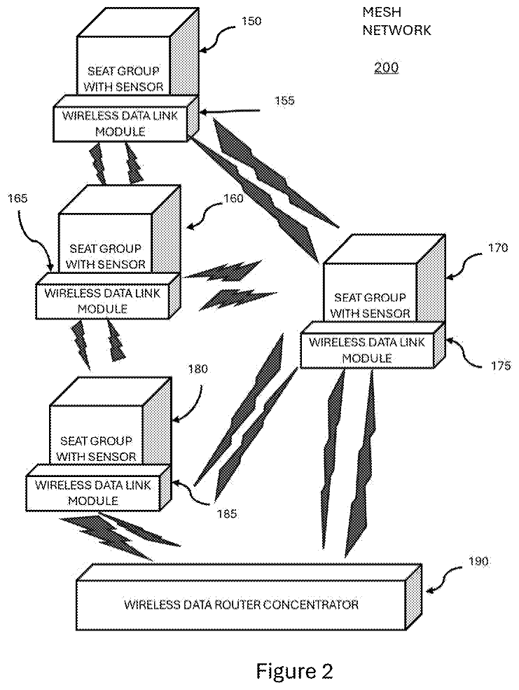

FIG. 2 illustrates the herein-described use of a mesh network to communicate information between the seat groups and ultimately to a cabin network. As shown in FIG. 2, one node of the mesh network (e.g., a wireless data link module) 155 associated with seat group 150 communicates with a nearby node (e.g., another wireless data link module 165 associated with seat group 160), which in turn relays this communication to another nearby node, e.g., 175, until the initial communication from the originating or first node is ultimately communicated to an endpoint, 185, which in turn communicates wirelessly to wireless data router concentrator 190, as described herein. The communication path is determined by the mesh network and may take alternate paths to optimize the communication flow. For example, in FIG. 2 the communication path may proceed from node 155 to 175 as the endpoint and then to the wireless data router concentrator 190. If one of the Wireless data link modules is removed the mesh network will determine another communication path to ensure data continues to flow between the wireless data link modules and the wireless data router concentrator.

In an embodiment, the present invention includes a wireless data router concentrator 125, as described herein. A wireless data router concentrator 125 functions to communicate with a cabin network of an aircraft. The wireless data router concentrator 125 also functions to collect data from the various wireless data link modules 120, which in turn collect data from the various sensors 110 associated with a particular seat. In this way, seat sensor data can ultimately be communicated to the cabin network of an aircraft for further processing and/or management. Similarly, the wireless data concentrator 125 functions to provide control functions or other communications from the cabin network to the various sensors 110 by routing those communications to the wireless data link network, which in turn communicates with the various seat sensors 110.

Aircraft AC power is typically 110V AC at 400-800 Hz. The wireless data router concentrator 125 may be powered from the aircraft AC power supply. Alternatively, a conventional 115V AC 50-60 Hz power source may be used in implementations where the wireless data router concentrator 125 is utilized in other mass transit vehicles. In yet another alternative implementation, the wireless data router concentrator 125 may alternatively be provided with 28 Volt DC aircraft power. The wireless data router concentrator 125 provides high-speed auto-negotiation Gigabit Ethernet interfaces, enabling the router to serve as an aggregation point for on-demand network connectivity. The wireless data router concentrator 125 can support one or more communication protocols, including 802.11 Wi-Fi 6/6e+, 802.15.4, and Bluetooth low energy connectivity. Additionally, the wireless data router concentrator 125 can optionally support Ethernet daisy-chain connectivity with one or more other wireless data router concentrators 125.

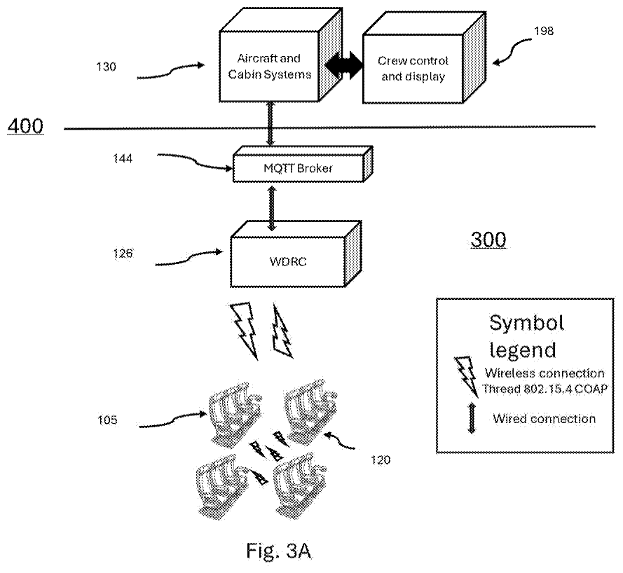

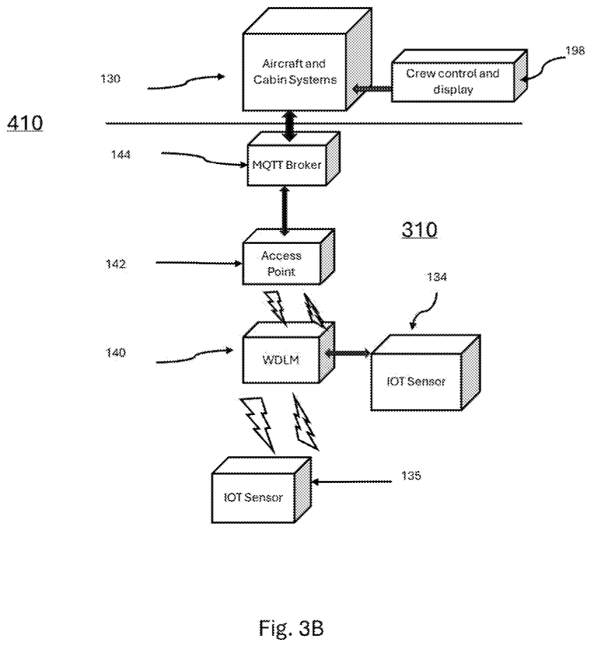

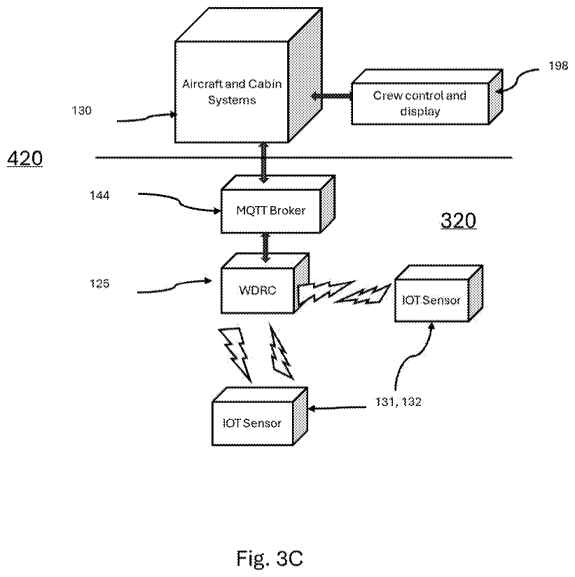

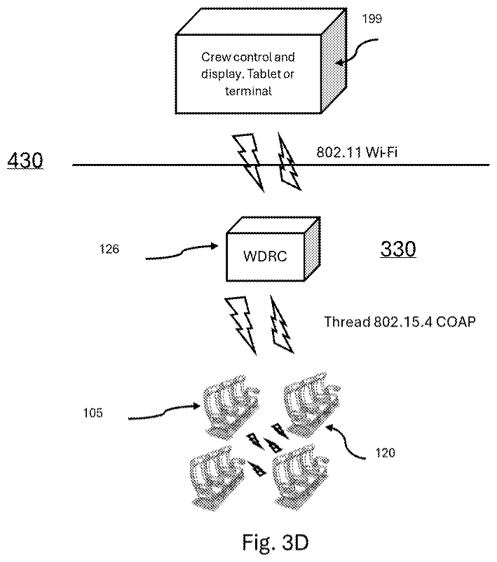

Referring now to FIG. 3A, therein is illustrated a sensor system 300 as part of an overall cabin electronics system 400. As shown in FIG. 3A, one or more seat groups 105 with associated sensors communicate with an installed wireless data link module 120, which in turn communicates with wireless data router concentrator 126. The wireless data router concentrator 126 communicates with MQTT broker 144 which then communicates with cabin system 130. In this implementation illustrated in FIG. 3A, there are multiple sensors in multiple seat groups utilizing one or more wireless data link modules 120 and a wireless data router concentrator 126 to communicate information with the cabin system 130. The cabin system 130 in turn may communicate information with crew control and display 198. In this way, communication may be provided between the various sensors and the aircraft and cabin system 130 and/or the crew control and display 198.

Referring now to FIG. 3B, therein is illustrated a sensor system 310 as part of an overall cabin electronics system 410. As shown in FIG. 3B, one or more wired IOT sensors 134 communicate via a wired connection with wireless data link module 140. Additionally, one or more wireless IOT sensors 135 communicate via a wireless connection with wireless data link module 140, such as by way of Thread, 802.15.4 or other communication protocol. The wireless data link module 140 provides further communication with access point 142, such as by way of a wireless communication link, such as Wi-Fi or 802.11. The wireless access point 142 in turn provides communication with MQTT broker 144, which in turn communicates with aircraft and cabin system 130. The aircraft and cabin system 130 may further be in communication with crew control and display 198. In this way, communication may be provided between the various sensors and the aircraft and cabin system 130 and/or the crew control and display 198. In the implementation illustrated in FIG. 3B, a wireless data router concentrator may not be necessary when there is a small number of sensors involved.

Referring now to FIG. 3C, therein is illustrated a sensor system 320 as part of an overall cabin electronics system 420. As shown in FIG. 3C, one or more wireless IOT sensors 131, 132 communicate via wireless communication with wireless data router concentrator 125. In turn, the wireless data router concentrator 125 communicates with MQTT broker 144, which in turn provides communications with aircraft and cabin system 130. The aircraft and cabin system 130 may further be in communication with crew control and display 198. In this way, communication may be provided between the various sensors and the aircraft and cabin system 130 and/or the crew control and display 198. In the implementation illustrated in FIG. 3C, a wireless data link module may not be necessary when there is a small number of sensors involved. Additionally, in such an implementation, there may not be a need for mesh network communication.

Referring now to FIG. 3D, therein is illustrated a sensor system 330 as part of an overall cabin electronics system 430. As shown in FIG. 3D, one or more seat groups 105 with associated sensors and one or more installed wireless data link modules 120 communicate with wireless data router concentrator 126, such as by way of Thread, 802.15.4 or other communication protocol. The wireless data router concentrator 126 communicates directly with crew control and display 199. In this way, communication may be provided between the various sensors and the crew control and display 199. In the embodiment illustrated in FIG. 3D, the system may be able to provide more direct communication with the various sensors 105 by way of wireless data router concentrator 126 which communicates directly with crew control and display 199.

The following references are incorporated herein by reference in their entirety:
Patent Publication JPH 0585491A; 1991-02-201993-04-06; Japan Airlines Co Ltd; Seat occupation monitoring system.
Patent Publication DE19606790A1; 1996-02-231997-08-28; Burgess Gmbh; Centralised automatic check on harness of aircraft passengers.
U.S. Pat. No. 6,477,753B1; 1997-11-172002-11-12; Breed Automotive Technology, Inc. Seat belt buckle.
Patent Publication US20030014166A1; *2000-11-202003-01-16; Chinigo Andrew M. Safety system for school buses.
Patent Publication EP1424250A2; 2002-11-272004-06-02; Cherry GmbH Device for checking the locking state of a seat belt buckle for vehicles.
Patent Publication DE102004025319A1; 2004-05-192005-12-22; Airbus Deutschland Gmbh Seat condition indication system for e.g. aircraft, has sensor arrangements with seat-occupancy and belt sensors to detect occupancy and closed condition of safety belt of seats, respectively.
Patent Publication US20070236917A1; 2006-04-072007-10-11; Tk Holdings Inc Lighted soft touch buckle for restraint system.
Patent Publication US20080048858A1; *2006-08-252008-02-28; Lueth Jacquelynn RSeatbelt fault alert system.
Patent Publication US20080068220A1; 2006-09-082008-03-20; Airbus Deutschland Gmbh Conditional aircraft cabin warning and signaling system for determining the cabin status.
Patent Publication DE102007019656A1; 2007-04-262008-10-30; Volkswagen Ag Seat for motor vehicle, has seat belt buckle and two electrical connections, which are connected by connection with impedance element and seat belt buckle is assigned to seat belt buckle switch.
Patent Publication US20090050393A1; *2007-08-212009-02-26; International Business Machines Corporation Seatbelt safety system.
Patent Publication US20090132128A1; *2007-11-202009-05-21; Tk Holdings Inc. Occupant monitoring and restraint status system.
Patent Publication US20090 177357A1; 2008-01-092009-07-09; International Business Machines Corporation Feedback loop system for passenger safety.
Patent Publication JP 2011068183A; 2009-09-242011-04-07; Tokai Rika Co Ltd Buckle device and seat belt device using the same.
Patent Publication WO2011052415A1; 2009-10-282011-05-05; Ashimori Industry Co., Ltd. Buckle device.
U.S. Pat. No. 8,427,294B2; *2008-03-312013-04-23; The Boeing Company Seat buckle configured for security and safety and associated methods.
Patent Publication US20150089777A1; 2013-10-022015-04-02; Yoke Industrial Corp. Safety belt buckle.
U.S. patent Ser. No. 10/005,563B2
Patent Publication CN106740656B
Patent Publication CA2948626C
Patent Publication DE1 9606790A1
U.S. patent Ser. No. 10/005,563B2
Patent Publication US2021 0253255A1
U.S. patent Ser. No. 10/035,492 B2
U.S. patent Ser. No. 10/464,678B2
US201 00283593A1
Patent Publication CN109071025B
Patent Application No. 62/317,694 entitled “Load Detector for a Vehicle Seat and Method of Detecting a Load in a Vehicle Seat” filed on April 2016.

1. A sensor status system for use in an aircraft or mass transit vehicle, the sensor status system comprising:
a plurality of sensors, each sensor associated with an item whose status is to be monitored, the plurality of sensors configured for communication with at least one sensor input module (SIM) to thereby provide sensor status information to the at least one sensor input module;
each sensor input module configured for communication with at least one wireless data link module (WDLM) to thereby provide sensor status information to the at least one wireless data link module;
wherein the at least one wireless data link module is configured for communication with an end user monitoring station to thereby provide sensor status information to the end user monitoring station.

2. The sensor status system of claim 1, wherein the communication between the plurality of sensors and the at least one sensor input module is wired or wireless.

3. The sensor status system of claim 1, wherein the communication between each sensor input module and the at least one wireless data link module is wired or wireless.

4. The sensor status system of claim 1, further comprising status and fault detection circuitry for monitoring sensor operation.

5. The sensor status system of claim 1, wherein the communication between the at least one wireless data link module and the end user monitoring station is by way of a mesh network.

6. The sensor status system of claim 1, further comprising a wireless data router concentrator configured to provide the communication between the at least one wireless data link module and the end user monitoring station.

7. The sensor status system of claim 6, wherein the communication between the wireless data router concentrator and the at least one wireless data link module is performed according to at least one of 802.11 protocol, 802.15 protocol, Wi-Fi protocol, and Bluetooth protocol.

8. The sensor status system of claim 6, further comprising a power source connected to the wireless data router concentrator, wherein the wireless data router concentrator is further configured to provide power to the at least one wireless data link module, which in turn is further configured to provide power to the at least one sensor input module, which in turn is further configured to provide power to at least one of the plurality of sensors.

9. The sensor status system of claim 8, wherein the power provided is by way of a wired or wireless connection.

10. The sensor status system of claim 1, wherein the end user monitoring station is configured to provide instructions to at least one of the plurality of sensors.

11. The sensor status system of claim 1, wherein the end user monitoring station includes a crew terminal of an aircraft.

12. A sensor status system for use in an aircraft or mass transit vehicle, the sensor status system comprising:
a plurality of sensors, each sensor associated with an item whose status is to be monitored, the plurality of sensors configured for communication with at least one sensor input module (SIM) to thereby provide sensor status information to the at least one sensor input module;
each sensor input module configured for communication with at least one wireless data link module (WDLM) to thereby provide sensor status information to the at least one wireless data link module;
a wireless data router concentrator configured to provide the communication between the at least one wireless data link module and an end user monitoring station to thereby provide sensor status information to the end user monitoring station.

13. The sensor status system of claim 12, wherein the communication between the plurality of sensors and the at least one sensor input module is wired or wireless.

14. The sensor status system of claim 12, wherein the communication between each sensor input module and the at least one wireless data link module is wired or wireless.

15. The sensor status system of claim 12, wherein the communication between the at least one wireless data link module and the end user monitoring station is by way of a mesh network.

16. The sensor status system of claim 12, further comprising a power source connected to the wireless data router concentrator, wherein the wireless data router concentrator is further configured to provide power to the at least one wireless data link module, which in turn is further configured to provide power to the at least one sensor input module, which in turn is further configured to provide power to at least one of the plurality of sensors.

17. A sensor status system for use in an aircraft or mass transit vehicle, the sensor status system comprising:
a plurality of sensors, each sensor associated with an item whose status is to be monitored, the plurality of sensors configured for communication to thereby provide sensor status information;
at least one wireless data link module (WDLM) configured to communicate with the plurality of sensors to thereby receive the sensor status information;
a wireless data router concentrator configured to communicate between the at least one wireless data link module and an end user monitoring station to thereby provide the sensor status information to the end user monitoring station.

18. The sensor status system of claim 17, wherein the communication between the plurality of sensors and the at least one wireless data link module is wired or wireless.

19. The sensor status system of claim 17, wherein the communication between the at least one wireless data link module and the end user monitoring station is by way of a mesh network.

20. The sensor status system of claim 12, further comprising a power source connected to the wireless data router concentrator, wherein the wireless data router concentrator is further configured to provide power to the at least one wireless data link module, which in turn is further configured to provide power to at least one of the plurality of sensors.

21. The sensor status system of claim 17, wherein the power provided is by way of a wired or wireless connection.

22. The sensor status system of claim 17, wherein the end user monitoring station is configured to provide instructions to at least one of the plurality of sensors.

23. The sensor status system of claim 17, wherein the end user monitoring station includes a crew terminal of an aircraft.
